(19) United States
(12) Patent Application Publication
(10) Pub. No.: US 2022/0009023 A1
(43) Pub. Date: Jan. 13, 2022

(54) METHODS OF ULTRASOUND ASSISTED 3D PRINTING AND WELDING

(71) Applicant: Qingyou Han, West Lafayette, IN (US)

(72) Inventor: Qingyou Han, West Lafayette, IN (US)

(73) Assignee: Dr. Qingyou Han, West Lafayette, IN (US)

(21) Appl. No.: 16/926,716

(22) Filed: Jul. 12, 2020

(51) Int. Cl. B23K 20/10; B33Y 10/00; B29C 64/153

(52) U.S. Cl. CPC B23K 20/10; B29C 64/153; B33Y 10/00

(57) ABSTRACT

Methods of ultrasound assisted 3D printing and welding involve the use of an ultrasonic sonotrode placed in on top of the solidified layer in the vicinity of a melt pool. The sonotrode, pressed against the solidified materials at the edge of the melt pool, is synchronized with the heat source such that it travels side-by-side with the melt pool to transmit ultrasonic vibrations to the solidifying melt pool, reducing hot tearing and porosity formation, and to consolidate the solidified materials under the sonotrode. The methods of the present invention are capable of making a large variety of commercially important alloys 3D printable and weldable.

### GRANT STATEMENT

None.

### FIELD OF THE INVENTION

The present invention relates to 3D printing and welding, and more specifically, to novel methods of ultrasound assisted 3D printing or welding for eliminating cracking, porosity, and delamination defects to make alloys printable or weldable.

### BACKGROUND OF THE INVENTION

Three-dimensional (3D) printing has found increased applications in the aerospace, automotive, biomedical, chemical, electrical, electronics, and medical industries. This disruptive technology allows for the building up of components layer by layer and thus increases design freedom and manufacturing flexibility for components of complex geometries. However, only very limited number of alloys, such as Al—Si based alloys, Ti-6A1-4V, CoCr, maraging steels, and Inconel 718, can be printed reliably. The vast majority of commercially important alloys cannot be 3D printed because of the formation of microstrctural defects such as hot tearing, porosity, and delamination between previous layers during the solidification process of the deposited droplets. Similar defects also occur during the welding process. There are a large number of unweldable alloys. Most of them are high-performance engineering alloys. The 3D printable alloys are in fact limited to those known to be easily weldable.

3D printing and welding have one thing in common. They are characterized by a small melt pool of a few millimeters in diameter caused by a traveling heat source which includes but is not limited to laser and electron beams for both 3D printing and welding, and flame and arc for welding. The small melt pool solidifies on a similar solid matrix, leading to an epitaxial growth of dendrites as large columnar grains which suppress the nucleation of new equiaxed grains in the melt pools. Work pieces consisting of large columnar grains are prone to hot tears, a type of crack that occurs at the end of solidification due to elemental segregation and internal stresses caused by solidification shrinkage of the liquid and thermal contraction of the solid dendrite net-work. Small equiaxed grains are known to resist hot tearing formation. Grain refining is a widely used technology for eliminating columnar grains and forming small equiaxed grains to prevent hot tearing during solidification, making alloys castable [1-3], weldable [4-5], and 3D printable [6-7].

There is an urgent need for making more commercially important alloys 3D printable. This crucial need is reflected in a recent technical article published in Nature, one of the most prestigious journals. To make high-strength aluminum alloys such as AA6061 and AA7075 3D printable, Martin et al. [6] mixed potent nucleant nanoparticles in powders of these alloys and successfully printed high strength solid components. However, nanoparticles are expensive. The addition of a significant amount of nanoparticles in the powders changes the chemistry and purity of the deposited alloy as well. Furthermore, it remains challenging to find a stable and potent nucleant for many commercially important alloys.

High-intensity ultrasonic vibration has been proven to be extremely effective in grain refining during welding [3-5] and 3D printing [8]. Han et al. [3-5] have demonstrated the use of high-intensity ultrasonic vibration in eliminating columnar grains and producing equiaxed grains during the welding of steel. Furthermore, unmixed zones in the weldment are also eliminated. The work was performed on a sheet metal bolt connected to the end surface of a sonotrode. It is difficult to extend this work onto the welding of two large pieces of sheet metal because it is impossible to maintain high-intensity ultrasonic vibration in a small liquid pool far away from the acoustic sonotrode fixed on the sheet metal. This means that the technology cannot be used for the welding of a long seam unless a large number of sonotrodes are used.

Chinese Pat. No. CN10704262A to Yao et al. discloses an ultrasound assisted platform for the 3D printing of materials. Instead of using one sonotrode on a piece of sheet metal [3-5], Yao et al. utilize a polarity of sonotrodes on a sheet metal which serves as the substrate for materials to be built on using 3D printing. The technology allows for the 3D printing of material over areas larger than that reported by Han et al. on welding [3-5]. However, the buildup of components on the substrate changes the natural frequency of the entire system and makes the system out of tune as the height of the component increases gradually. Also, a large number of ultrasonic units and significant amount of energy are required to vibrate the platform, which is very expensive.

Todaro et al. have recently employed high-intensity ultrasound on printing of Ti-6A1-4V and Inconel 625 samples and achieved full transition from columnar grains to fine (˜100 nm) equiaxed grains [8]. Their work was directly performed on the end surface of the sonotrode of 25 mm in diameter. This small sized sonotrode can achieve high-intensity ultrasonic vibrations. Such a technology, however, is incapable of processing a part much larger than the diameter of the sonotrode. Furthermore, as the part is gradually built up layer by layer during laser deposition, the length of the sonotrode and its resultant natural frequency are gradually varied. For the ultrasonic system to work, all the components of the ultrasonic stack, including the sonotrode, have to be specifically tuned to resonate at the same exact ultrasonic frequency. When the natural frequency of the sonotrode is gradually varied during 3D printing, the system will be gradually out of tuned. This means the results reported by Todaro et al. are good only for very small samples with a cross-sectional area about that of the sonotrode and height within tens of millimeters.

Prior arts have demonstrated that high-intensity ultrasonic vibration is capable of eliminating hot tearing in small melt pools on very small samples. No work has been reported in open literature on preventing porosity and delamination from occurring during 3D printing or welding. In addition, no work on using high-intensity ultrasonic vibration to assist 3D printing or welding of a large work piece has been reported in the open literature either.

Therefore, there is a need for developing a novel method and apparatus for 3D printing and welding suitable for grain refining during the solidification of small melt pools formed under a traveling heat source for making large components or a large number of small components on a large platform. Such a new technology enables 3D printing or welding of a large variety of commercially important alloys which are otherwise unprintable or unweldable.

### SUMMARY OF THE INVENTION

The present invention provides methods of ultrasound assisted 3D printing and welding utilizing a sonotrode that is placed in close vicinity to the melt pool and travels with the melt pool so that ultrasonic vibrations can be transmitted to the melt pool to produce small equiaxed grains. The formation of small equiaxed grains during the solidification of the melt pool significantly reduces hot tearing and porosity formation in the solidified components.

In another embodiment, the invention relates to the methods of ultrasound assisted 3D printing and welding. A rolling sonotrode or a sonotrode with a circular tip is used so that the sonotrode can be synchronized with the traveling melt pool to ensure that the ultrasound energy is focused only on the melt pool and its vicinity materials. As a result, the traveling sonotrode is capable of processing large components.

In another embodiment, the invention relates to the methods of ultrasound assisted 3D printing and welding. A compressive thrust load is applied on the sonotrode placed on just the solidified materials to ensure an effective transmission of ultrasonic energy to the melt pool and the solidified materials nearby and under the sonotrode.

In another embodiment, the invention relates to the methods of ultrasound assisted 3D printing and welding. In addition to grain refining in the solidifying melt pool which reduces hot tearing and porosity in the solidified material, the combined action of the compressive load on the solidified materials and the ultrasound induced stresses in the solid material further consolidates the materials under the sonotrode, which is extremely effective in closing cracks and pores that may still exist in the materials solidified from the liquid pool. Thus, the present invention is capable of making some conventionally unprintable or unweldable materials printable or weldable. Materials free from internal defects such as cracks and pores are much stronger that those with internal defects.

In a further embodiment, the present invention relates to the methods of ultrasound assisted liquid deposition process or welding process wherein the liquid pool may consist of similar or dissimilar materials to the solid substrate that it deposits on. By consolidating dissimilar liquid material to the solid substrate, components with layered materials or structures result.

### BRIEF DESCRIPTION OF THE DRAWINGS

FIGS. 1A and 1B are schematic representations of an ultrasound assisted 3D printing method using a rolling sonotrode in accordance with this invention.

FIGS. 2A and 2B are schematic representations of an ultrasound assisted 3D printing method using a sonotrode vibrating in the direction perpendicular to the top surface of the melt pool in accordance with this invention.

FIG. 3 is a schematic representation an ultrasound assisted welding method using a rolling sonotrode in accordance with this invention.

FIG. 4 is a schematic representation of an ultrasound assisted welding method using a sonotrode vibrating in the direction perpendicular to the top surface of the melt pool in accordance with this invention.

FIG. 5 is the Pb—Sn phase diagram showing the large solidification interval of the Pb-20% Sn alloy described in the example of this invention.

FIGS. 6A and 6B disclose comparable micrographs of grain structure in samples that have or have not been subjected to ultrasonic vibration, respectively.

FIGS. 7A and 7B disclose comparable micrographs of hot tearing in samples that have or have not been subjected to ultrasonic vibration, respectively.

FIGS. 8A and 8B disclose comparable micrographs of porosity formation in samples that have or have not been subjected to ultrasonic vibration, respectively.

### DETAILED DESCRIPTION OF THE INVENTION

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

The present invention teaches to synchronize a high-intensity ultrasonic vibration system and a heat source so that the sonotrode and the melt pool travel side-by-side, to focus very high power density (VHPD) ultrasonic vibrations on the solidified material in close vicinity of the melt pool, and to apply a compressive thrust load on the ultrasonic vibrators. The combination of VHPD ultrasonic vibrations and compressive force allows 1) to vibrate the small melt pool to achieve grain refining and eliminating hot tearing and porosity, 2) to hot work on the material just solidified while it is still near the solidus temperature or even semi-solid temperatures, 3) to bond the just solidified material to the layer previously deposited, and 4) to hot work and cold work material previously deposited. Here the heat sources include but are not limited to laser, electron beams, flames, and arcs. Power density is defined as the energy of power per unit area at the end surface of a sonotrode, and the melt pool is fed either by a powder nozzle, a wire feeder, or by consuming powder bed.

The melt pool to be treated is only within millimeters in diameter during 3D printing or welding. Thus, a very small sonotrode tip is needed for processing such a small melt pool. Ultrasonic energy can be focused on such a small tip to achieve VHPD. Assuming the tip diameter is 3 mm, ultrasonic vibrations at the power level of 10 W would generate power densities over 140 W/cm² at the end surface of the sonotrode, which is high enough to induce cavitations in molten aluminum. By placing the sonotrode on the just solidified material in close vicinity to the melt pool, attenuation of ultrasonic energy from the sonotrode to the melt pool is minimized, and the majority of the acoustic energy can be transferred to the melt pool to produce equiaxed grains and to eliminate hot tearing and porosity. In the mean time, the just solidified hot material under the sonotrode is hot pressed under the influence of VHPD ultrasonic vibration which promotes further consolidation and grain deformation. Ultrasonic consolidation of materials at high temperatures under compression is extremely effective in closing cracks, porosity, and delamination between layers. Furthermore, the cold material previously solidified is also subject to VHPD ultrasonic vibration. High-intensity ultrasonic vibrations are capable of increasing dislocation density and nano-sized grains in the solid material during cold working [3, 9].

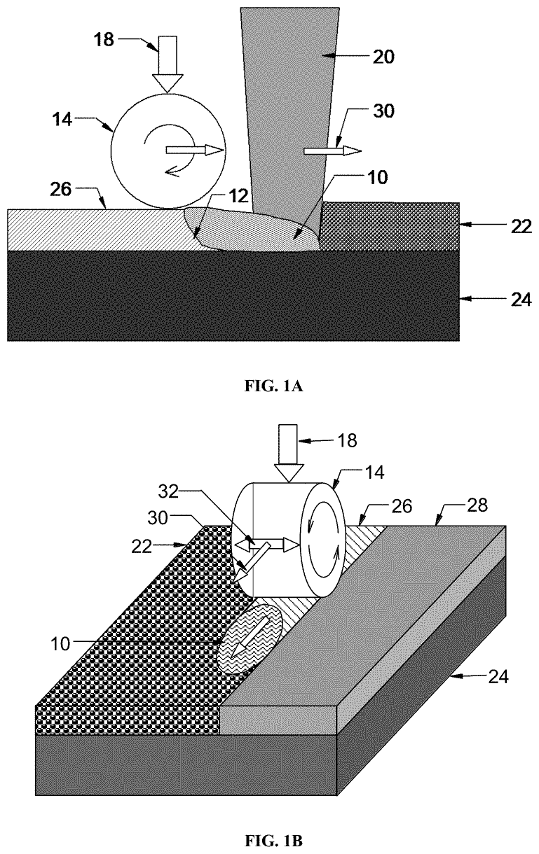

FIG. 1 illustrates a preferred ultrasound assisted 3D printing process using a rolling sonotrode 14 vibrating in the direction 32 parallel to the top surface of the powder bed 22 or the solidified materials of the currently scan layer 28. In this method, shown in FIG. 1A and FIG. 1B, the heat source 20 melts the materials in the powder bed 22 and forms the melt pool 10. The rolling sonotrode 14 is placed either on top of the solidified materials 26 close to the edge of the melt pool 10, partially on top of the melt 10, or on top of the solidified material 28 close to the melt pool 10. The rolling sonotrode 14 is synchronized with the heat source 20 so that it travels in the same direction as illustrated by arrow 30 at that same speed as that of the melt pool 10. As the heat source 20 travels over the powder bed 22, the melt pool 10 consumes the powder bed 22 and solidifies on the previously deposited layer 24 and the just solidified materials 26 in the current scan and the solidified materials on the currently scanned layer 28. The solid-liquid interface 12 is a boundary separating the melt 10 from the solids 22, 24, 26, and 28. VHPD acoustic vibrations vibrating in the direction as illustrated by arrow 32 are transmitted from the rolling sonotrode 14 to the melt pool 10, causing cavitations in the melt 10 and interface 12 related convections that break up columnar dendrites into fragments of equiaxed dendrites. VHPD acoustic vibrations are also applied on the just solidified materials 26 in the current scan for further consolidation of the hot material and on the previous solidified materials 24 and 28 for cold working of the cold material. The compressive load 18 applied on the rolling sonotrode 14 ensures improved transmission of the VHPD vibrations to the materials nearby and enhances the deformation and consolidation of materials under the rolling sonotrode 14.

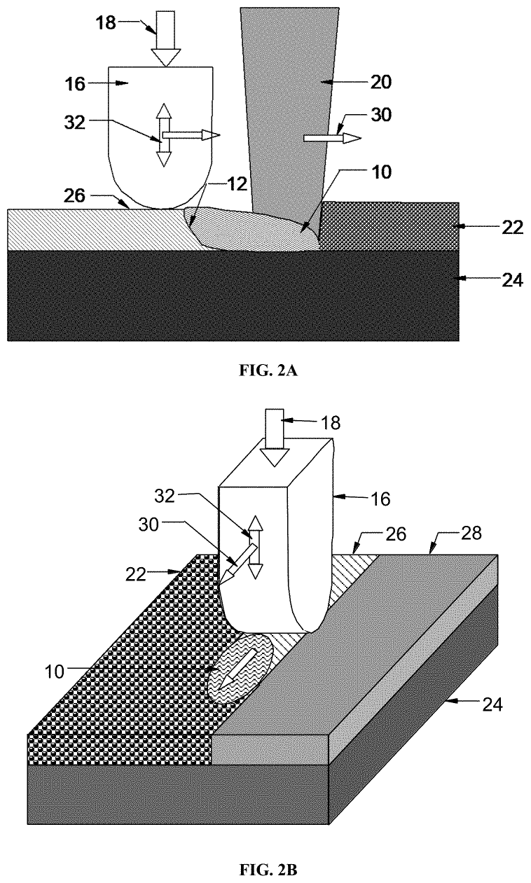

FIG. 2 illustrates a preferred ultrasound assisted 3D printing process using a sonotrode 16 vibrating in the direction 32 perpendicular to the top surface of the powder bed 22 or the solidified materials of the currently scan layer 28. In this method, shown in FIG. 2A and FIG. 2B, the heat source 20 melts the materials in the powder bed 22 and forms the melt pool 10. The sonotrode 16 is placed either on top of the solidified materials 26 close to the edge of the melt pool 10, partially on top of the melt 10, or on top of the solidified material 28 close to the melt pool 10. The sonotrode 16 is synchronized with the heat source 20 so that it travels in the same direction as illustrated by arrow 30 at that same speed as that of the melt pool 10. As the heat source 20 travels over the powder bed 22, the melt pool 10 consumes the powder bed 22 and solidifies on the previously deposited layer 24 and the just solidified materials 26 in the current scan and the solidified materials of the currently scan layer 28. The solid-liquid interface 12 is a boundary separating the melt 10 from the solids 22, 24, 26, and 28. VHPD acoustic vibrations vibrating in the direction as illustrated by arrow 32 are transmitted from the rolling sonotrode 16 to the melt pool 10, causing cavitations in the melt 10 and interface 12 related convections that break up columnar dendrites into fragments of equiaxed dendrites. VHPD acoustic vibration is also applied on the just solidified materials 26 in the current scan for further consolidation of the hot material and on the previous solidified materials 24 and 28 for cold working of the cold material. The compressive load 18 applied on the sonotrode 16 ensures improved transmission of the VHPD vibrations to the materials nearby and enhances the deformation and consolidation of materials under the sonotrode 16.

The present invention related to ultrasound assisted 3D printing can be applied to printing materials including polymers, metallic materials, and composite materials containing ceramic particles to produce 3D solid components of high internal quality and high mechanical properties.

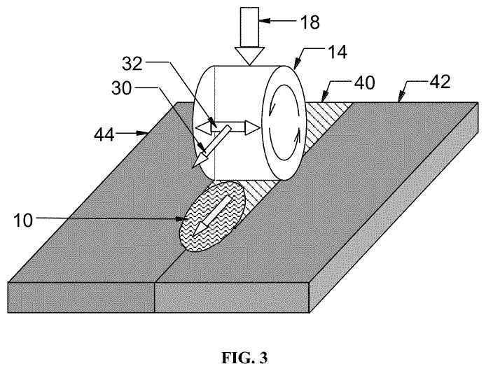

FIG. 3 illustrates a preferred ultrasound assisted welding process using a rolling sonotrode 14 vibrating in the direction 32 parallel to the top surface of the sheet materials, 42 and 44, to be welded. In this method, the heat source melts the materials of the welding wire and sheet materials 42 and 44, and forms the melt pool 10. The rolling sonotrode 14 is placed either on top of the solidified seam 40 close to the edge of the melt pool 10, partially on top of the melt 10, or on top of the sheet material 42 or 44 close to the melt pool 10. The rolling sonotrode 14 is synchronized with the heat source so that it travels in the same direction as illustrated by arrow 30 at that same speed as that of the melt pool 10. VHPD acoustic vibrations vibrating in the direction as illustrated by arrow 32 are transmitted from the rolling sonotrode 14 to the melt pool 10, causing cavitations in the melt 10 that break up columnar dendrites into fragments of equiaxed dendrites. VHPD acoustic vibration is also applied on the just solidified materials 40 for further consolidation of the hot material. The compressive load 18 applied on the rolling sonotrode 14 ensures improved transmission of the VHPD vibrations to the nearby materials and enhances the deformation and consolidation of materials under the rolling sonotrode 14.

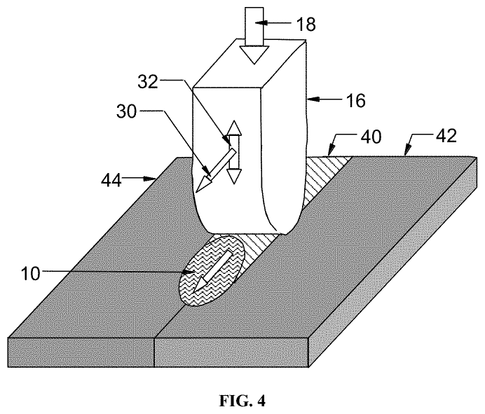

FIG. 4 illustrates a preferred ultrasound assisted welding process using a sonotrode 16 vibrating in the direction 32 perpendicular to the top surface of the sheet materials, 42 and 44, to be welded. In this method, the heat source melts the materials of the welding wire and sheet materials 42 and 44 and forms the melt pool 10. The sonotrode 16 is placed either on top of the solidified seam 40 close to the edge of the melt pool 10, partially on top of the melt 10, or on top of the sheet material 42 or 44 close to the melt pool 10. The sonotrode 16 is synchronized with the heat source so that it travels in the same direction as illustrated by arrow 30 at that same speed as that of the melt pool 10. VHPD acoustic vibrations vibrating in the direction as illustrated by arrow 32 are transmitted from the sonotrode 16 to the melt pool 10, causing cavitations in the melt 10 that break up columnar dendrites into fragments of equiaxed dendrites. VHPD acoustic vibrations are also applied on the just solidified materials 40 for further consolidation of the hot material. The compressive load 18 applied on the sonotrode 16 ensures improved transmission of the VHPD vibration to the nearby materials and enhances the deformation and consolidation of materials under the sonotrode 16.

The present invention related to an ultrasound assisted welding process can be applied to weld materials including metallic materials and composite materials containing ceramic particles to produce solid weldment of high internal quality and high mechanical properties.

The invention further provides examples of ultrasound assisted welding of metallic materials. The examples provided below are meant merely to exemplify several embodiments, and should not be interpreted as limiting the scope of the claims, which are delimited only by the specification.

### Example

The inventor of the present invention and Dr. S. Bagherzadeh have validated the approach shown in FIG. 4 for eliminating hot tearing, porosity, and delamination on a Pb-20% Sn alloy using a sonotrode with a hemispherical tip. The sonotrode was bolt connected to an ultrasonic horn made of Ti-6A1-4V. The horn was driven by a 1.5 kW acoustic generator and an air-cooled 20 kHz transducer made of piezoelectric lead zirconate titanate (PZT) crystals. A Ronson Tech torch was used as the heat source. Ultrasonic systems employing higher frequencies of 40 kHz to 60 kHz with lower amplitude vibrations are preferably used for materials less ductile.

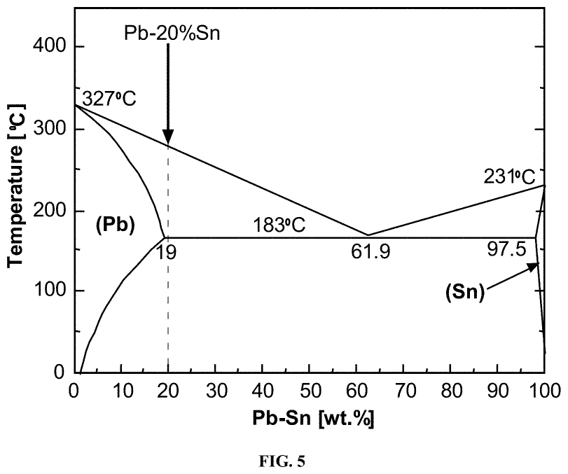

FIG. 5 shows the Pb—Sn phase diagram. Pb-20% Sn alloy has the largest solidification interval on the phase diagram. It is well known that alloys that have large solidification interval are difficult to weld and print due to hot tearing and porosity formation.

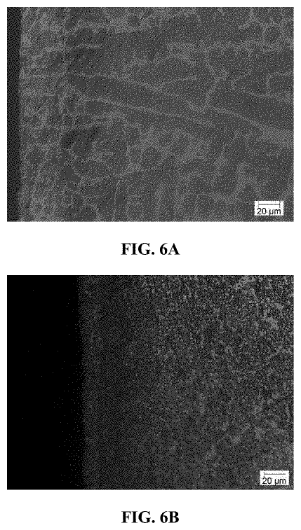

FIG. 6A shows the columnar grains formed in the melt pool in the sample without ultrasonic vibration. Long and large columnar grains prevail throughout the solidified melt pool. With ultrasonic vibrations, small equiaxed grains, shown in FIG. 6B, are obtained. The vibrating sonotrode is effective in eliminating large columnar grains and producing small equiaxed grains during the solidification of the melt pool.

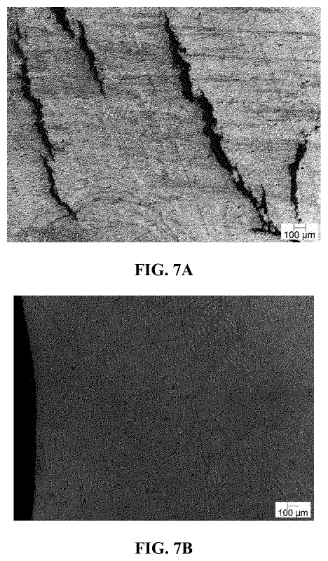

FIG. 7A shows large hot tearing in a sample without ultrasonic vibration and FIG. 7B shows the solidified microstructure containing no hot tearing in a sample with ultrasonic vibration. Ultrasonic vibration is effective in producing small equiaxed grains in the melt pool, thus eliminating hot tearing defect.

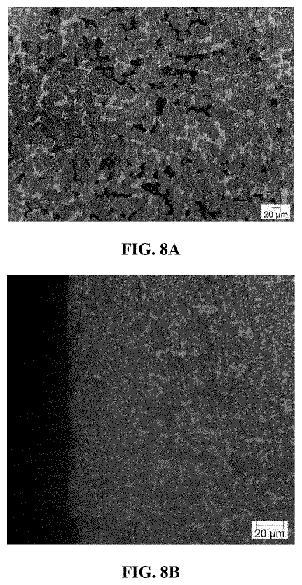

FIG. 8A shows porosity in a sample without ultrasonic vibration and FIG. 8B shows the solidified microstructure containing limited porosity in a sample with ultrasonic vibration. Ultrasonic vibration is effective in driving pores out of the melt pool and results in much less porosity formation.

While the invention has been described in connection with specific embodiments thereof, it will be understood that the inventive methodology is capable of further modifications. This patent application is intended to cover any variations, uses, or adaptations of the invention following, in general, the principles of the invention and including such departures from the present disclosure as come within known or customary practice within the art to which the invention pertains and as may be applied to the essential features herein before set forth and as follows in scope of the appended claims.

### REFERENCES

1. D. G. McCartney, “Grain Refining of Aluminum and Its Alloys Using Inoculants,” International Materials Reviews, vol. 34, 1989, pp. 247-260.
2. L. Han, C. Vian, J. Song, Z. Liu, Q. Han, C. Xu, and L. Shao, “Grain Refining of Pure Aluminum,” Light Metals, 2012, pp. 967-971.
3. Q. Han, “Ultrasonic Processing of Materials,” Metallurgical and Materials Transaction B, vol. 46, 2015, pp. 1620-1625.
4. Y. Cui, C. Xu, and Q. Han, “Microstructure Improvement in Weld Metal Using Ultrasonic Vibration,” Advanced Engineering Materials, vol. 9, 2007, pp. 161-163.
5. Y. Cui, C. Xu, and Q. Han, “Effect of Ultrasonic Vibration on Unmixed Zone Formation,” Scripta Materialia, vol. 55, 2006, pp. 975-978.
6. J. H. Martin, B. D. Yahata, J. M. Hundley, J. A. Mayer, T. A. Schaedler, and T. Pollock, “3D Printing of High-Strength Aluminum Alloys,” Nature, vol. 549, 2017, pp. 365-379.
7. P. C. Collins, D. A. Brice, P. Samimi, I. Ghamarian, and H. L. Fraser, “Microstructural Control of Additively Manufactured Metallic Materials,” Annual Review of Materials Research, vol. 46, 2016, 63-91.
8. C. J. Todaro, M. A. Easton, D. Qiu, D. Zhang, M. J. Bermingham, E. W. Lui, M. Brandt, D. H. StJohn, and M. Qian, “Grain Structure Control during Metal 3D Printing by High-Intensity Ultrasound,” Nature Communications, January 2020, pp. 1-15.
9. O. V. Abramov, High-Intensity Ultrasonics: Theory and Industrial Applications, Gorden & Breach Science Publisher, The Netherlands, 1998.

What is claimed is:

1. A method for forming high internal quality and high mechanical property 3D printing articles, comprising the step of:
forming a melt pool by melting solid materials using a heat source conventionally used for 3D printing;
placing the acoustic sonotrode of an ultrasonic vibration system in close vicinity of the melt pool for transmitting high-intensity ultrasonic vibration to the melt pool;
applying a compressive thrust load on the sonotrode;
synchronizing the sonotrode and the heat source such that the sonotrode and the melt pool travel side-by-side at a fixed distance between them; and
applying ultrasonic vibrations through the sonotrode to transmit the vibrations to the materials under or nearby the sonotrode, including the solidifying material in the melt pool.

2. A method of claim 1, wherein the melt pool is formed by melting solid materials, consisting of metallic materials, polymers, or composite materials, using a laser or an electron beam and wherein the solid materials are provided in the form of a wire using a wire feeding mechanism, powders using a powder-feeding mechanism, or powders in a powder bed.

3. A method of claim 1, wherein the ultrasonic vibration is applied either on the just solidified material close to the edge of the melt pool or partially on the top of the melt pool so that ultrasonic vibration is transmitted to the melt pool as well as the just solidified materials near the weld pool.

4. A method of claim 1, wherein the sonotrode is either a rolling sonotrode vibrating substantially parallel to the plane of the contact surfaces or a sonotrode vibrating substantially perpendicular to the plane of the contact surfaces.

5. A method of claim 1, wherein the sonotrode is wide enough to cover at least one or more scans width of printed materials.

6. A method of claim 1, wherein the ultrasonic vibration is applied at a frequency between about 10 kHz and about 200 kHz, at a power level between about 1 watt and about 10,000 watts.

7. A method of claim 1, wherein the compressive thrust load is high enough to ensure effective transmission of ultrasonic vibration to the melt pool to form small equiaxed grains during the solidification of the melt pool.

8. A method of claim 1, wherein the sonotrode is made of titanium alloy, aluminum alloy, steel, or ceramic materials.

9. A method for forming high internal quality and high mechanical property welding of solid articles, comprising the step of:
forming a melt pool by melting solid materials using a heat source conventionally used for welding;
placing the acoustic sonotrode of an ultrasonic vibration system in close vicinity of the melt pool for transmitting high-intensity ultrasonic vibration to the melt pool;
applying a compressive thrust load on the sonotrode;
synchronizing sonotrode and the heat source such that the sonotrode and the melt pool travel side-by-side at a fixed distance between them; and
applying ultrasonic vibration through the sonotrode to transmit the vibrations to the materials under or nearby the sonotrode, including the solidifying material in the melt pool.

10. A method of claim 9, wherein the melt pool is formed by melting solid metallic materials using a heat source including but not limited to flame, arc, laser, and electron beam and wherein the solid materials are provided in the form of a wire using a wire feeding mechanism or powders using a powder-feeding mechanism.

11. A method of claim 9, wherein the ultrasonic vibration is applied either on the just solidified material close to the edge of the melt pool or partially on the top of the melt pool so that ultrasonic vibration is transmitted to the melt pool as well as the just solidified materials near the weld pool.

12. A method of claim 9, wherein the sonotrode is either a rolling sonotrode vibrating substantially parallel to the plane of the contact surfaces or a sonotrode vibrating substantially perpendicular to the plane of the contact surfaces.

13. A method of claim 9, wherein the sonotrode is wide enough to cover the just solidified materials.

14. A method of claim 9, wherein the ultrasonic vibration is applied at a frequency between about 10 kHz and about 200 kHz, at a power level between about 1 watt and about 10,000 watts.

15. A method of 9, wherein the compressive thrust load is high enough to ensure effective transmission of ultrasonic vibration to the melt pool to form small equiaxed grains during the solidification of the melt pool.

16. A method of 9, wherein the sonotrode is made of titanium alloy, aluminum alloy, steel, or ceramic materials.

17. A method for forming high internal quality and high mechanical property solid articles with layered structure, comprising the step of:
placing the acoustic sonotrode of an ultrasonic vibration system in close vicinity of where the liquid material is to be deposited on a solid substrate;
applying a compressive thrust load on the sonotrode;
synchronizing sonotrode and the liquid deposition system such that the sonotrode and the deposited liquid material travel side-by-side at a fixed distance between them;
depositing liquid material, and
applying ultrasonic through the sonotrode to the deposited liquid material during its solidification process.

18. A method of claim 17, wherein the deposition process includes but not limited to potting, coating, painting, filling, and spray.

19. A method of claim 17, wherein the liquid material, similar or dissimilar to the solid substrate, includes metallic, polymer, and ceramic material at its liquid state or semi-solid state.

20. A method of claim 17, wherein the sonotrode is either a rolling sonotrode vibrating substantially parallel to the plane of the contact surfaces or a sonotrode vibrating substantially perpendicular to the plane of the contact surfaces.
